(19) United States
(12) Patent Application Publication
(10) Pub. No.: US 2014/0017503 A1
(43) Pub. Date: Jan. 16, 2014

(54) HEAT RAY-SHIELDING LAMINATE AND FILM ROLL THEREOF

(71) Applicants: Masao Hashimoto, Yokohama-shi (JP); Yuji Suzuki, Yokohama-shi (JP)

(72) Inventors: Masao Hashimoto, Yokohama-shi (JP); Yuji Suzuki, Yokohama-shi (JP)

(73) Assignee: BRIDGESTONE CORPORATION, Chuo-Ku, Tokyo (JP)

(21) Appl. No.: 14/004,476

(22) PCT Filed: Mar. 27, 2012
(86) PCT No.: PCT/JP2012/057864

§ 371 Date: Sep. 11, 2013

(30) Foreign Application Priority Data
Mar. 29, 2011 (JP) 2011-071437

(51) Int. Cl. G02B 5/20

(52) U.S. Cl. CPC G02B 5/208
USPC 428/421

(57) ABSTRACT

Provided is a heat ray-shielding laminate having an ethylene-vinyl acetate copolymer layer and a fluoro resin layer which can be adjacent to each other which can be stored for a long period of time. A heat ray-shielding laminate 10 including an ethylene-vinyl acetate copolymer layer 12 containing a silane coupling agent and a fluoro resin layer 14 containing a tungsten oxide and/or composite tungsten oxide, wherein the ethylene-vinyl acetate copolymer layer 12 and the fluoro resin layer 14 are arranged adjacent to each other, or arranged in the form of outermost layers which face each other, wherein the silane coupling agent is represented by the following formula (I) R²—Si(OR¹)₃ (I) in which each R¹ is an alkyl group having 2 to 5 carbon atoms, and R² is an ethylenically unsaturated group or a group having an ethylenically unsaturated group, and wherein the silane coupling agent is contained in an amount of 0.1 to 2.5 parts by weight based on 100 parts by weight of the ethylene-vinyl acetate copolymer.

### TECHNICAL FIELD

The present invention relates to a heat ray-shielding laminate and a film roll thereof which can be stored for a long period of time.

### BACKGROUND ART

In order to reduce air-conditioning loads of buildings such as office buildings and vehicles such as buses, autos and trains, heat ray-shielding glasses capable of shielding near-infrared ray (heat ray) have been used as window glasses of the buildings and vehicles for a long time (for example, Patent document 1). A heat ray-shielding glass is generally produced by bonding a film laminate having heat ray-shielding properties to a glass plate. As the film laminate having heat ray-shielding properties, known is a laminate having a heat ray-shielding layer formed on one side of a plastic film and an adhesive resin layer for bonding to a glass plate superposed on the other side of the plastic film or on the heat ray-shielding layer. In addition, a heat ray-shielding laminated glass having two glass plates and an intermediate film which has a heat ray-shielding layer and adhesive resin layers and which is sandwiched between the two glass plates is known (Patent document 2).

As adhesive resin of the adhesive resin layer, ethylene-vinyl acetate copolymer (EVA) is generally used. The adhesion of the adhesive resin layer is enhanced by addition of a silane coupling agent. The heat ray-shielding layer is formed by dispersing a tungsten oxide as a heat ray-shielding agent in a binder resin, applying the dispersion onto a plastic film, and then drying it. As the binder resin, a fluoro resin is generally used because it is excellent in preventing bluing caused by the tungsten oxide.

The heat ray-shielding glass or laminated glass is generally produced by preparing a plastic film on which a heat ray-shielding layer is formed and an EVA film (adhesive resin layer) at a film-producing manufacturer, and then transporting the films to a heat ray-shielding glass-producing manufacturer wherein the films are bonded and combined with glass plate(s).

### PRIOR ART DOCUMENTS

### Patent Document

Patent Document 1: JP (TOKKAI) 2011-006271 A
Patent Document 2: JP (TOKKAI) 2009-062409 A
Patent Document 3: JP (TOKKAI) 2001-121657 A

### SUMMARY OF THE INVENTION

### Problem to be Solved by the Invention

However, when a film laminate having a heat ray-shielding layer containing a fluoro resin (fluoro resin layer) and an EVA layer which are arranged adjacent to each other is stored for a long period of time, the adhesion of the EVA layer may be reduced over time. Therefore, it is necessary to bond the film laminate to a glass plate in a short period of time from the preparation of the film laminate, or to store the each film separately till the each film is bonded to a glass plate. It is therefore difficult to produce heat ray-shielding glasses efficiently.

Such film laminate is generally produced in the form of a roll in view of handling when stored and transported. Therefore even if a fluoro resin layer and an EVA layer are not directly adjacent to each other, a film laminate having the each layer arranged in outermost layer is wound to bring about the contact of the EVA layer with the fluoro resin layer, whereby the adhesion of the EVA layer may be reduced.

Patent document 2 discloses a laminate having a fluoro resin layer and an EVA layer which are arranged adjacent to each other. The laminate has a structure comprising a first EVA layer which contains substantially no silane coupling agent and which is formed on one side of a fluoro resin layer, and a second EVA layer which contains a silane coupling agent and which is formed on the other side of the first EVA layer, thereby improving the adhesion of the EVA layers. However, Patent document 2 does not describe a problem of reduction of the adhesion of the EVA layer due to long term storage. In addition, the structure of the laminate is complicated.

It is therefore an object of the present invention to provide a heat ray-shielding layer comprising an ethylene-vinyl acetate copolymer layer containing a silane coupling agent and a fluoro resin layer containing a tungsten oxide and/or composite tungsten oxide, which suppresses reduction of the adhesion of the EVA layer which may be caused by long term storage.

In addition, it is an object of the present invention is to provide a heat ray-shielding intermediate film for a laminated glass comprising the above-mentioned heat ray-shielding laminate, which can be stored for a long period of time.

Furthermore, it is an object of the invention is to provide a film roll suitable for long term storage which is prepared by winding the above-mentioned heat ray-shielding laminate or heat ray-shielding intermediate film for a laminated glass.

### Means for Solving Problem

The adhesion of an EVA layer which contains a silane coupling agent and is adjacent to a fluoro resin is reduced over time. The reduction of the adhesion is considered to be caused by products formed by condensation reactions of the silane coupling agent bleeding to the surface of the EVA layer. As a result of studying various silane coupling agents, the inventor has found that the use of a silane coupling agent having alkoxy groups having 2 to 5 carbon atoms as hydrolysable groups can reduce formation of the products inhibiting the adhesion, thereby suppressing the reduction in the adhesion during long term storage.

Therefore, the above-mentioned object is achieved by a heat ray-shielding laminate which comprises an ethylene-vinyl acetate copolymer layer containing a silane coupling agent and a fluoro resin layer containing a tungsten oxide and/or composite tungsten oxide,

wherein the ethylene-vinyl acetate copolymer layer and the fluoro resin layer are arranged adjacent to each other, or arranged in the form of outermost layers which face each other,

wherein the silane coupling agent is represented by the following formula (I)

R²—Si(OR¹)₃ (I)

in which each R¹ is an alkyl group having 2 to 5 carbon atoms, and R² is an ethylenically unsaturated group or a group having an ethylenically unsaturated group, and

wherein the silane coupling agent is contained in an amount of 0.1 to 2.5 parts by weight based on 100 parts by weight of the ethylene-vinyl acetate copolymer.

Preferred embodiments of the present invention are as follows:

(1) Each R¹ is an ethyl group.

(2) After the laminate having the ethylene-vinyl acetate copolymer layer and the fluoro resin layer which are adjacent to each other is allowed to stand for six months under conditions of a temperature of 30° C. and a humidity of 80% RH, a glass plate is superposed on the ethylene-vinyl acetate copolymer layer and then the ethylene-vinyl acetate copolymer layer is cross-linked and cured to have the adhesion of the ethylene-vinyl acetate copolymer layer to the glass plate of not less than 3N/cm, the adhesion being measured according to JIS K 6854-2.

(3) The heat ray-shielding laminate further comprises a transparent plastic film.

In addition, the above-mentioned object is achieved by a heat ray-shielding intermediate film for a laminated glass, which comprises the heat ray-shielding laminate of the present invention.

Further, the above-mentioned object is achieved by a film roll obtained by winding the heat ray-shielding laminate or the heat ray-shielding intermediate film for a laminated glass according to the present invention.

### Effect of the Invention

The present invention enables a heat ray-shielding laminate and a heat-ray shielding intermediate film for a laminated glass to be stored for a long period of time. Accordingly, after the heat ray-shielding laminate or the intermediate film is produced, they can be stocked in large numbers. Therefore, when needed, they can be transported or used for the preparation of a heat ray-shielding glass or laminated glass, thereby improving the productivity.

### BRIEF DESCRIPTION OF THE DRAWINGS

FIG. 1 is a schematic sectional view showing an embodiment of a heat ray-shielding laminate of the present invention.

FIG. 2 is a schematic sectional view showing another embodiment of a heat ray-shielding laminate of the present invention.

FIG. 3 is a schematic sectional view showing a condition in which the heat ray-shielding laminates shown in FIG. 2 are superposed.

FIG. 4 is a schematic sectional view showing an embodiment of a heat ray-shielding intermediate film for a laminated glass of the present invention.

FIG. 5 is a schematic sectional view showing an embodiment of a heat ray-shielding glass of the present invention.

FIG. 6 is a schematic sectional view showing another embodiment of a heat ray-shielding glass of the present invention.

FIG. 7 is a schematic sectional view showing an embodiment of a heat ray-shielding laminated glass of the present invention.

FIG. 8 is a schematic view explaining a 180° peel test for evaluating adhesion.

### DESCRIPTION OF EMBODIMENTS

As described above, a heat ray-shielding laminate of the present invention comprising an ethylene-vinyl acetate copolymer layer (EVA layer) and a fluoro resin layer such that the EVA layer and the fluoro resin layer are arranged adjacent to each other, or arranged in the form of outermost layers which face each other.

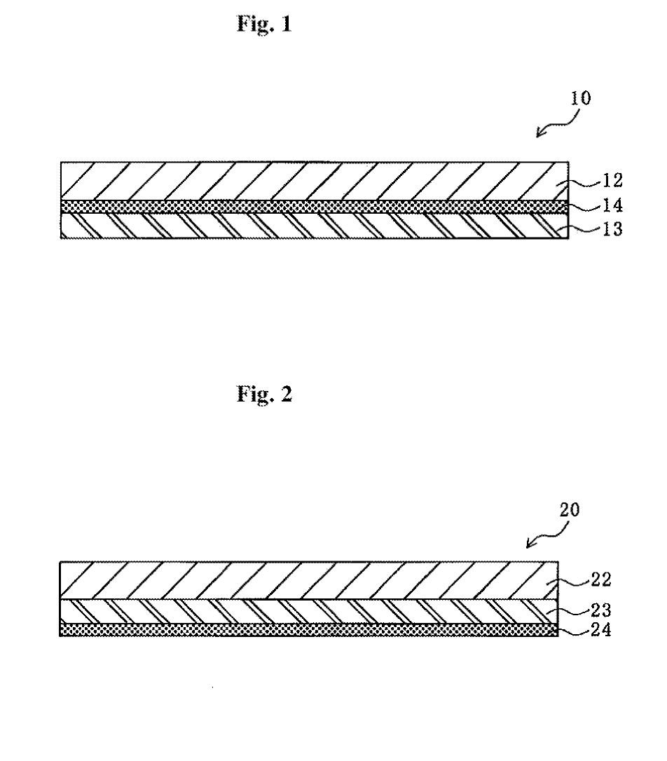

Examples of the heat ray-shielding laminate having an EVA layer and a fluoro resin layer which are arranged adjacent to each other include, as shown in FIG. 1, a laminate 10 composed of a transparent plastic film 13, a fluoro resin layer 14 formed on the transparent plastic film 13, and an EVA layer 12 superposed on the fluoro resin layer 14. Examples of the heat ray-shielding laminate having an EVA layer and a fluoro resin layer which are arranged in the form of outermost layers which face each other include, as shown in FIG. 2, a laminate 20 composed of a transparent plastic film 23, a fluoro resin layer 24 formed on one side of the transparent plastic film 23, and an EVA layer 22 superposed on the other side of the transparent plastic film 23. The present invention is described in detail below.

[Silane Coupling Agent]

In the present invention, the silane coupling agent contained in the EVA layer is represented by the following formula (I)

R²—Si(OR¹)₃

wherein each R¹ is an alkyl group having 2 to 5 carbon atoms, and R² is an ethylenically unsaturated group or a group having an ethylenically unsaturated group.

Silane coupling agents having alkyl groups having less than two carbon atoms as R¹, i.e. methyl groups, have excessive reactivity and therefore they may bleed to the surface of the EVA layer and then polycondense to form products inhibiting the adhesion of the EVA layer. Silane coupling agents having alkyl groups having not less than six carbon atoms as R¹ have poor reactivity, and thus sufficient adhesion cannot be obtained.

In case where R² is a group defined as above, high adhesion can be obtained. Examples of the ethylenically unsaturated group include vinyl group, methacryloxy group (methacryloyloxy group) and acryloxy group (acryloyloxy group). Specific examples of R² include vinyl group, γ-methacryloxypropyl group, γ-acryloxypropyl group, γ-methacryloxyethyl group and γ-methacryloxymethyl group.

Preferred examples of the silane coupling agent represented by the formula (I) include γ-methacryloxypropyltriethoxysilane, γ-methacryloxypropyltripropoxysilane, γ-methacryloxypropyltributoxysilane, γ-methacryloxypropyltripentoxysilane, vinyltriethoxysilane, vinyltripropoxysilane, vinyltributoxysilane and vinyltripentoxysilane.

Particularly preferred are γ-methacryloxypropyltriethoxysilane and vinyltriethoxysilane both of which have ethyl groups as R¹.

In the present invention, the silane coupling agent is contained in an amount of 0.1 to 2.5 parts by weight, preferably 0.1 to 2.0 parts by weight, particularly preferably 0.5 to 2.0 parts by weight, based on 100 parts by weight of ethylene-vinyl acetate copolymer. When the silane coupling agent is used in an amount of less than 0.1 part by weight, sufficient adhesion may not be obtained. When the silane coupling agent is used in an amount of more than 2.5 parts by weight, the silane coupling agent may bleed out.

[Ethylene-Vinyl Acetate Copolymer Layer]

In the present invention, the content of vinyl acetate in ethylene-vinyl acetate copolymer is in the range of 20 to 35% by weight, preferably 22 to 30% by weight, particularly 24 to 28% by weight, based on the ethylene-vinyl acetate copolymer. When the content is less than 20% by weight, transparency of a film obtained by cross-linking and curing the film at high temperature may be insufficient. When the content is more than 35% by weight, carboxylic acids, alcohols or amines are formed, and thus bubble formation may occur at boundaries between adjacent layers.

The EVA layer in the present invention may secondarily contain polyvinyl acetal resin such as polyvinyl formal, polyvinyl butyral (PVB resin) or modified PVB, or vinyl chloride resin, in addition to ethylene-vinyl acetate copolymer. The PVB resin is preferred. EVA preferably has Melt Flow Index (MFR) of 4.0 to 30.0 g/10 min., especially 8.0 to 18.0 g/10 min.

The EVA layer preferably comprises a crosslinker. This can improve cross-linking density of EVA to give excellent adhesion. As the crosslinker, an organic peroxide is preferably used.

Any organic peroxides that can be decomposed at a temperature of not less than 100° C. to generate radical(s) can be employed as the above-mentioned organic peroxide. The organic peroxide is selected in the consideration of film-forming temperature, conditions for preparing the composition, curing (bonding) temperature, heat resistance of body to be bonded, storage stability. Especially, preferred are those having a decomposition temperature of not less than 70° C. in a half-life of 10 hours.

Examples of the organic peroxides include t-butylperoxy-2-ethylhexylcarbonate, 2,5-dimethylhexane-2,5-dihydroperoxide, 2,5-dimethyl-2,5-di(t-butylperoxy)hexane-3-di-t-butylperoxide, t-butylcumyl peroxide, 2,5-dimethyl-2,5-di(t-butylperoxy)hexane, dicumyl peroxide, α,α′-bis(t-butylperoxyisopropyl)benzene, n-butyl-4,4-bis(t-butylperoxy)valerate, 1,1-bis(t-butylperoxy)cyclohexane, 1,1-bis(t-butylperoxy)-3,3,5-trimethylcyclohexane, t-butylperoxybenzoate, benzoyl peroxide, t-butylperoxyacetate, methyl ethyl ketone peroxide, 2,5-dimethylhexyl-2,5-bisperoxybenzoate, butyl hydroperoxide, p-menthane hydroperoxide, p-chlorobenzoyl peroxide, hydroxyheptyl peroxide, chlorohexanone peroxide, octanoyl peroxide, decanoyl peroxide, lauroyl peroxide, cumyl peroxyoctoate, succinic acid peroxide, acetyl peroxide, m-toluoyl peroxide, t-butylperoxyisobutylate and 2,4-dichlorobenzoyl peroxide.

The organic peroxide is preferably contained in an amount of 1 to 10 parts by weight, particularly 1 to 5 parts by weight, based on 100 parts by weight of EVA.

The EVA layer may further contain a cross-linking auxiliary. The cross-linking auxiliary can enhance the cross-linking density of ethylene-vinyl acetate copolymer and improve the adhesion and durability of the EVA layer.

The cross-linking auxiliary is used in an amount of 0.1 to 3.0 parts by weight, preferably 0.1 to 2.5 parts by weight, based on 100 parts by weight of EVA. By setting the ranges as above, occurrence of gases due to the addition of the cross-linking auxiliary can be prevented, and the cross-linking density of ethylene-vinyl acetate copolymer can be improved.

Examples of the crosslinking auxiliary (compounds having radical polymerizable groups as functional groups) include trifunctional crosslinking auxiliaries such as triallyl cyanurate and triallyl isocyanurate, and mono- or bifunctional crosslinking auxiliaries of (meth)acryl esters (e.g., NK Ester, etc.). Among these, triallyl cyanurate and triallyl isocyanurate are preferred. Triallyl isocyanurate is particularly preferred.

[Fluoro Resin Layer]

In the present invention, the fluoro resin layer may be formed on an appropriate substrate, for example, a plastic film, or used as a fluoro resin sheet itself.

Examples of the fluoro resin include polytetrafluoroethylene (PTFE), tetrafluoroethylene/hexafluoropropylene copolymer (FEP), tetrafluoroethylene/perfluoroalkyl vinylether copolymer (PFA), polyvinylidene fluoride (PVDF), polychlorotrifluoroethylene (PCTFE), tetrafluoroethylene/ethylene copolymer (ETFE), fluoroethylene vinyl ether resin (FEVE) and ethylene/chlorotrifluoroethylene copolymer (ECTFE), and polymer A having the following structure:

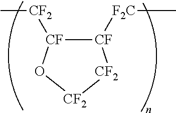

wherein n is 10 to 1,000. Of these resins, the polymer A and fluoroethylene vinyl ether resin (FEVE) are preferred. These (co)polymers may have functional group(s) (e.g., alkoxysilyl group, hydroxyl group, amino group, imino group, (meth)acryloyloxy group, epoxy group, carboxyl group, sulfonyl group, acrylate-containing isocyanurate group, sulfate group). Examples of commercially available fluoro resin include Cytop available from Asahi Glass Co., Ltd., Zeful available from Daikin Industries, Ltd., Optool available from Daikin Industries, Ltd. These resins are thermoplastic, thermosetting or photo (UV) curable resin. When they are cured, if necessary, curing agent or crosslinker is preferably used.

[Tungsten Oxide and/or Composite Tungsten Oxide]

The fluoro resin layer contains a tungsten oxide and/or composite tungsten oxide.

The tungsten oxide is generally represented by a general formula W_{y}O_{z} wherein W represents tungsten, O represents oxygen, and y and z satisfy the condition of 2.2≦z/y≦2.999. Further, the composite tungsten oxide has a composition obtained by adding, to the tungsten oxide, element M (M represents at least one element selected from H, He, alkaline metals, alkaline-earth metals, rare-earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi and I). Hence, free electrons are generated in W_{y}O_{z} even in case of z/y=3.0, and absorption properties derived from the free electrons develop in the region of near-infrared rays, whereby the W_{y}O_{z} is useful as material absorbing near-infrared rays at approx 1,000 nm. In the invention, preferred is composite tungsten oxide.

In the tungsten oxide of the general formula W_{y}O_{z} wherein W represents tungsten and O represents oxygen, and y and z satisfy the condition of 2.2≦z/y≦2.999, a preferred composition range of tungsten and oxygen is a composition ratio of oxygen to tungsten of less than 3, particularly of 2.2≦z/y≦2.999 when the infrared shielding material is described as W_{y}O_{z}. When z/y is not less than 2.2, occurrence of unnecessary WO₂ crystalline phase in infrared shielding material can be prevented and the chemical stability of the material can be obtained, whereby the tungsten oxide can be used in effective infrared shielding material. In contrast, when z/y is not more than 2.999, free electrons can be generated in the required amount whereby the resultant infrared shielding material has high efficiency.

The composite tungsten oxide is preferably represented by a general formula MₓW_{y}O_{z} wherein M represents at least one element selected from H, He, alkaline metals, alkaline-earth metals, rare-earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi and I, W represents tungsten, O represents oxygen, and x, y and z satisfy the conditions of 0.001≦x/y≦1 and 2.2≦z/y≦3, in view of stability. The alkaline metals are elements in 1st group of Periodical Table of the Elements except for hydrogen, the alkaline-earth metals are elements in 2nd group of Periodical Table of the Elements, and the rare-earth elements are Sc, Y and lanthanide elements. Particularly, from the viewpoint of enhancement of optical properties and weather resistance, M element is preferably one or more elements selected from Cs, Rb, K, Tl, In, Ba, Li, Ca, Sr, Fe and Sn.

Further the composite tungsten oxide is preferably treated with a silane coupling agent, whereby the resultant oxide shows excellent dispersing properties and hence brings about excellent infrared shielding properties and transparency.

When x/y which represents the addition amount of M is more than 0.001, free electrons can be generated in a sufficient amount whereby the resultant infrared shielding material shows sufficient heat shielding effect. The amount of free electrons is increased with increase of the addition amount of the element M, which results in enhancement of infrared shielding effect, but the amount of free electrons is saturated when x/y attains approx. 1. In contrast, when x/y is less than 1, occurrence of an impurities phase in the fluoro resin layer can be preferably prevented.

Also in the composite tungsten oxide represented by a general formula MₓW_{y}O_{z}, a value of z/y which represents control of oxygen amount functions in the same manner as in the infrared shielding material represented by W_{y}O_{z}. In addition, the free electrons are provided depending on the addition amount of the element M even in case of z/y=3.0, and therefore z/y is preferably 2.2≦z/y≦3.0, more preferably 2.45≦z/y≦3.0.

In case the composite tungsten oxide has crystal structure of hexagonal crystal, the oxide is enhanced in transmission in visual light region and in absorption in near-infrared region.

In case where a cation of element M exists in voids of hexagonal shape of the hexagonal crystal by the addition of the element M, the transmission in visual light region and the absorption in near-infrared region are enhanced. In general, the addition of element M having large ion radius brings about the formation of the hexagonal crystal, particularly the addition of Cs, K, Rb, Tl, In, Ba, Sn, Li, Ca, Sr, Fe facilitates the formation of the hexagonal crystal. Naturally, it is effective that even an addition element other than the above-mentioned elements exists in voids of the hexagonal shape formed from WO₆ units, and hence the addition element is not restricted to the above-mentioned elements.

In case where the composite tungsten oxide having hexagonal crystal has uniform crystal structure, the addition amount of the addition element M is preferably set as a value of x/y to 0.2 to 0.5, more preferably 0.33. It is considered that x/y of 0.33 results in the addition element M being placed in all voids of the hexagonal shape.

Tungsten bronze having tetragonal or cubical crystal besides hexagonal crystal also has infrared shielding effect. The absorption position in near-infrared region is apt to vary depending upon the crystal structures, and the absorption position tends to move in the longer wavelength direction in the order of tetragonal<cubical<hexagonal crystal. With this tendency, the absorption in visual light region is apt to become small in the order of hexagonal<cubical<tetragonal crystal. Therefore, in use (application) that is required to transmit highly visual light and to shield highly infrared rays, it is preferred to use tungsten bronze having hexagonal crystal.

The average particle size of the tungsten oxide and/or composite tungsten oxide is preferably in the range of 10 to 800 nm, especially 10 to 400 nm in order to retain the transparency. This is because particle having the average particle size of less than 800 nm do not completely screen light due to scattering and therefore make it possible to retain visibility in the visible light region and simultaneously effectively transparency. In case of particularly emphasizing transparency of the visible light region, it is preferred to consider the scattering of the particle. In case of considering the reduction of the scattering, the average particle size is preferably in the range of 20 to 200 nm, more preferably 20 to 100 nm. The average particle size of the particle is determined by observing a section view of the fluoro resin layer at 1,000,000-fold magnification by a transmission electron microscope and measuring diameters of circles corresponding to projected areas of at least 100 particles to determine their average value.

The tungsten oxide and/or composite tungsten oxide is, for example, prepared as follows.

The tungsten oxide represented by a general formula W_{y}O_{z} and/or the composite tungsten oxide represented by a general formula MₓW_{y}O_{z} can be obtained by subjecting a starting material of a tungsten compound to heat treatment under an inert gas or reducing gas atmosphere.

Examples of the starting material of tungsten compound preferably include tungsten trioxide powder, tungsten oxide hydrate, tungsten hexachloride powder, ammonium tungstate powder, tungsten oxide hydrate powder obtained by dissolving tungsten hexachloride in alcohol and drying it, tungsten oxide hydrate powder obtained by dissolving tungsten hexachloride in alcohol, forming precipitation by addition of water and drying the precipitation, tungsten compound powder obtained by drying an ammonium tungstate aqueous solution, and metal tungsten powder, and one or more of the examples can be also used.

In order to facilitate the preparation of the tungsten oxide, it is more preferred to use tungsten oxide hydrate powder or tungsten compound powder obtained by drying an ammonium tungstate aqueous solution. The preparation of composite tungsten oxide is more preferably carried out by using an ammonium tungstate aqueous solution or a tungsten hexachloride solution because the solution of starting material easily enables homogeneous mixing of elements to be used. Thus, the tungsten oxide and/or the composite tungsten oxide having the particle size as mentioned above can be obtained by subjecting the above-mentioned material(s) to heat treatment under an inert gas or reducing gas atmosphere.

The composite tungsten oxide represented by a general formula MₓW_{y}O_{z} can be prepared by using a starting material of tungsten oxide containing an element of M or an M-containing compound though in the same manner as the starting material of tungsten oxide of a general formula W_{y}O_{z}. In order to prepare a starting material in which used components are homogeneously mixed in molecular level, solutions of components are preferably mixed with each other. Hence it is preferred that a tungsten compound containing element M is dissolvable in a solvent such as water, or organic solvent. For example, there are mentioned tungstate, chloride, nitrate, sulfate, oxalate or oxide containing element M. However, these are not restricted, and any in the form of solution can be preferably used.

The heat treatment under an inert gas atmosphere is preferably carried out in the condition of 650° C. or higher. The starting material heat-treated at 650° C. or higher has sufficient coloring power and hence brings about heat ray-shielding material having excellent efficiency. Examples of the inert gas include preferably Ar and N₂. Further, the heat treatment under a reducing gas atmosphere is preferably carried out by heating a starting material at a temperature of 100 to 650° C. under a reducing gas atmosphere and heating at a temperature of 650 to 1200° C. under an inert gas atmosphere. Example of the reducing gas preferably includes H₂, but is not restricted to. In case H₂ is used as the reducing gas, a composition of the reducing gas has preferably not less than 0.1% by volume of H₂, more preferably not less than 2% by volume of H₂. Use of not less than 0.1% by volume of H₂ enables the reduction to effectively promote.

The material powder reduced with hydrogen contains magnelli phase and shows excellent infrared shielding properties, and hence the material powder can be used as heat ray-shielding agent without modification. However, since hydrogen contained in tungsten oxide is unstable, its application may be restricted in view of weather resistance. By subjecting the tungsten oxide containing hydrogen to heat treatment at temperature of 650° C. or higher under an inert gas atmosphere, further stable heat ray-shielding material can be obtained. Though the atmosphere in the heat treatment is not restricted, the atmosphere preferably includes N₂ or Ar in view of industrial aspect. The heat treatment at a temperature of 650° C. or higher brings about formation of magnelli phase in the heat ray-shielding material whereby weather resistance is enhanced.

The composite tungsten oxide has been preferably subjected to surface treatment by a coupling agent such as a silane coupling agent, a titanate coupling agent or an aluminum coupling agent. The silane coupling agent is preferred. Hence, the composite tungsten oxide becomes to have excellent compatibility with binder resin, which results in improvement of various properties such as transparency, heat ray-shielding properties.

The fluoro resin layer preferably contains the tungsten oxide and/or composite tungsten oxide in an amount of 10 to 500 parts by weight, preferably 20 to 500 parts by weight, particularly 30 to 300 parts by weight, based on 100 parts by weight of the fluoro resin.

[Heat Ray-Shielding Laminate and Heat Ray-Shielding Intermediate Film for a Laminated Glass]

As described above, the heat ray-shielding laminate of the present invention is a laminate which comprises an ethylene-vinyl acetate copolymer layer containing a silane coupling agent and a fluoro resin layer containing a tungsten oxide and/or composite tungsten oxide. The EVA layer and the fluoro resin layer are arranged adjacent to each other, or arranged in the form of outermost layers which face each other.

The EVA layer can be prepared, for example, by kneading EVA and the above-mentioned materials, if necessary on heating, to give a mixture, and subjecting the mixture to a conventional molding process such as extrusion molding or calendaring to form a sheet-shaped material. Otherwise, the sheet-shaped material can be also obtained by dissolving the mixture in an appropriate solvent to form a solution and applying the solution onto an appropriate support by means of a coater such as a roll coater, a knife coater and a doctor blade, and then drying it. The temperature for preparing the film is preferably in the range of 40 to 90° C., particularly 50 to 80° C. The EVA layer has a thickness of, for example, 50 μm to 2 mm, particularly 300 μm to 1 mm.

The fluoro resin layer can be obtained by applying, onto a transparent film, a coating liquid prepared by dispersing fine particles of a tungsten oxide and/or composite tungsten oxide in a fluoro resin, and then drying the applied liquid, and, if necessary, further curing the applied liquid by light. In general, a step dispersing a tungsten oxide and/or composite tungsten oxide in a fluoro resin is carried out by preliminarily using a roll mill, a sand mill or an attritor mill. The fluoro resin layer generally has a thickness of 0.1 to 50 μm, preferably 0.1 to 10 μm, particularly preferably 0.1 to 5 μm. Examples of the transparent plastic film include a polyethylene terephthalate (PET) film, a polyethylene naphthalate (PEN) film or a polyethylene butyrate film. Especially preferred is PET film. The transparent plastic film preferably has a thickness of 10 to 400 μm, particularly 20 to 300 μm.

In the present invention, examples of the heat ray-shielding laminate having an EVA layer and a fluoro resin layer which are arranged adjacent to each other include, as shown FIG. 1, a laminate 10 composed of a transparent plastic film 13, a fluoro resin layer 14 formed on one side of the transparent plastic film 13, and an EVA layer 12 superposed on the fluoro resin layer 14.

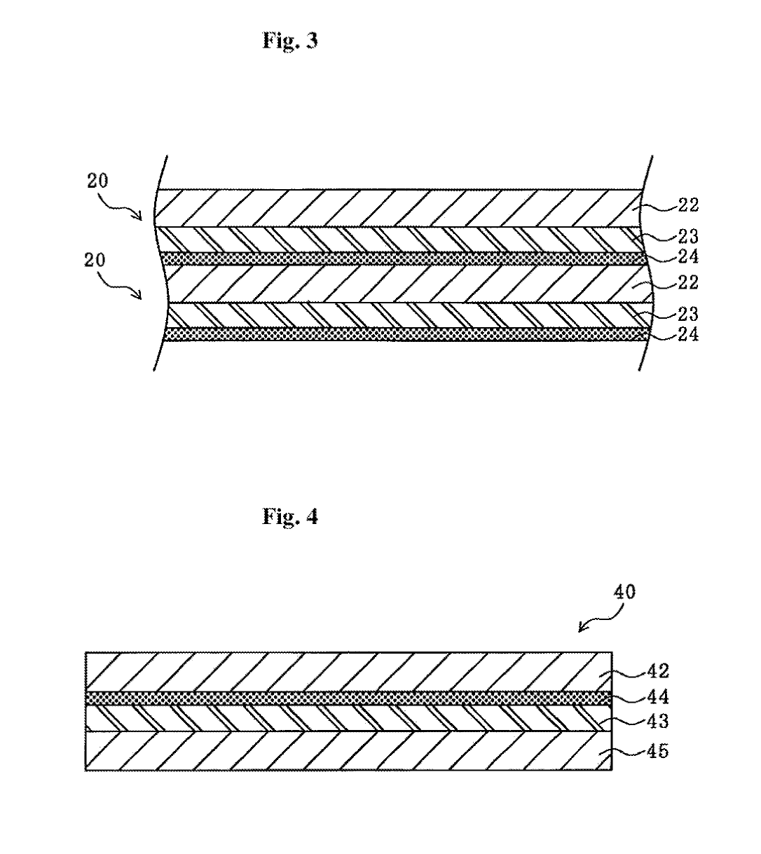

In the present invention, examples of the heat ray-shielding laminate having an EVA layer and a fluoro resin layer which are arranged in the form of outermost layers which face each other include, as shown in FIG. 2, a laminate 20 composed of a transparent plastic film 23, a fluoro resin layer 24 formed on one side of the transparent plastic film 23, and an EVA layer 22 superposed on the other side of the transparent plastic film 23. In this case, the EVA layer 22 and the fluoro resin layer 24 are not directly adjacent to each other in the laminate 20. However, when the laminate 20 is wound for storage, as shown in FIG. 3, the EVA layer 22 and the fluoro resin layer 24 are adjacent to each other. According to the present invention, even if film laminates having this structure are stored for a long period of time, reduction of the adhesion of the EVA layer can be suppressed.

The present invention provides a heat ray-shielding intermediate film for a laminated glass, comprising the heat ray-shielding laminate of the present invention. Examples of the heat ray-shielding intermediate film for a laminated glass include, as shown in FIG. 4, a intermediate film 40 composed of a transparent plastic film 43, a fluoro resin layer 44 formed on the transparent plastic film 43, an EVA layer 42 superposed on the fluoro resin layer 44, and an adhesive resin layer 45 (for example, an EVA film) superposed on the other side of the transparent plastic film 43.

The heat ray-shielding laminates shown in FIG. 1 and FIG. 2 and the intermediate film for a laminated glass shown in FIG. 4 can be produced by superposing the layers as described above, and then bonding them by applying pressure and heat. The laminate temperature of this case is, for example, in the range of 80 to 110° C.

In the present invention, the EVA layers 12, 22, 42 each function as an adhesive resin layer. The fluoro resin layers 14, 24, 44 each function as a heat ray-shielding layer. The heat ray-shielding laminate and intermediate film can be stored for a long period of time, and thus are effective as a heat ray-shielding laminate and intermediate film for long period storage. The term “long” refers to a period of not less than three months, preferably not less than six months, particularly from six months to two years.

The film roll of the present invention can be prepared by laminating the layers as described above and then winding the laminate by a known manner such as a surface winding method. Roll shaped products are suitable for handling when stored and transported.

[Heat Ray-Shielding Glass and Heat Ray-Shielding Laminated Glass]

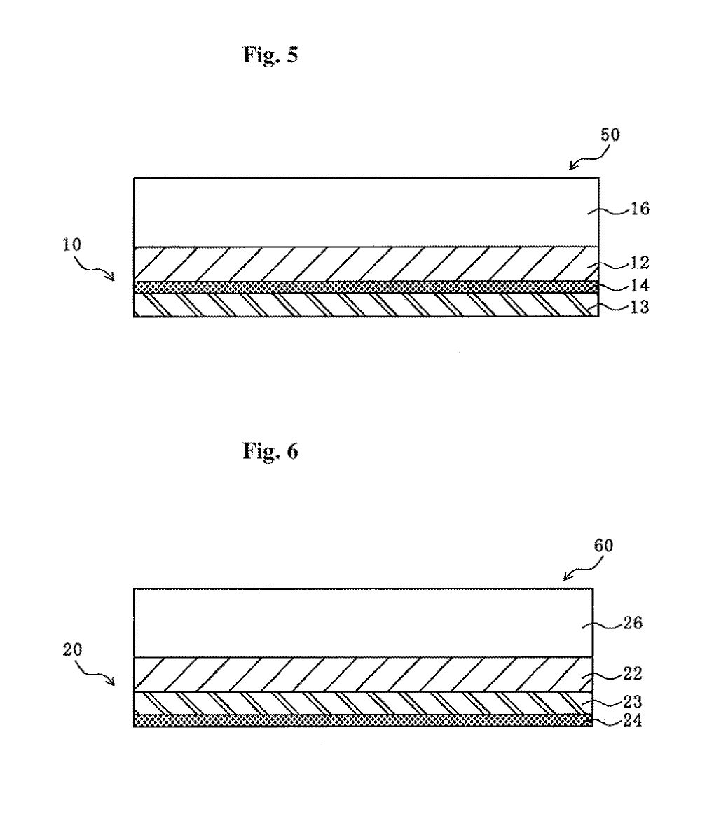

The heat ray-shielding glass of the present invention has the heat ray-shielding laminate as described above. FIG. 5 is a schematic sectional view showing a heat ray-shielding glass 50 having the laminate 10 shown in FIG. 1. The heat ray-shielding glass 50 can be prepared by superposing a glass plate 16 on the other side of the EVA layer 12 of the heat ray-shielding laminate 10, and then bonding and combing them.

FIG. 6 is a schematic sectional view showing a heat ray-shielding glass 60 having the laminate 20 shown in FIG. 2. The heat ray-shielding glass 60 can be prepared by superposing a glass plate 26 on the other side of the EVA layer 22 of the heat ray-shielding laminate 20, and then bonding and combining them.

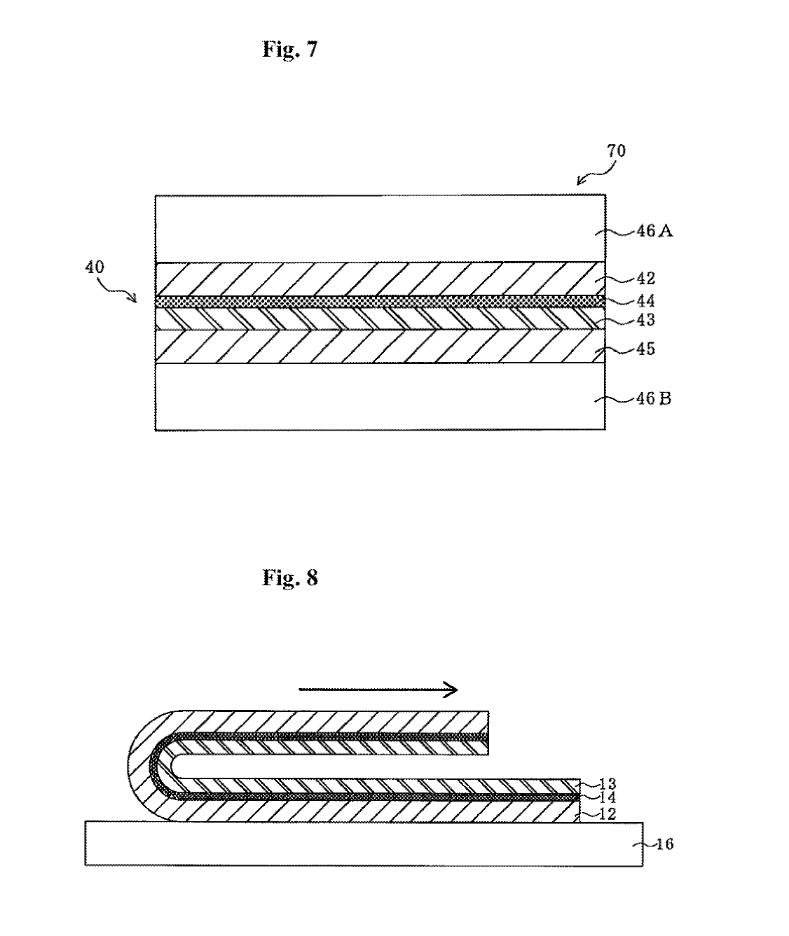

The heat ray-shielding laminated glass of the present invention has the heat ray-shielding intermediate film for a laminated glass. FIG. 7 is a schematic sectional view showing a laminated glass 70 prepared by using the intermediate film for a laminated glass 40. The laminated glass 70 can be prepared by providing a glass plate 46A on the other side of the EVA layer 42, and providing a glass plate 46B on the other side of the adhesive resin layer 45, and then bonding and combing them.

In the invention, after the heat ray-shielding laminate of the present invention having the ethylene-vinyl acetate copolymer layer and the fluoro resin layer which are adjacent to each other is allowed to stand for six months under conditions of a temperature of 30° C. and a humidity of 80% RH, a glass plate is superposed on the ethylene-vinyl acetate copolymer layer and then the ethylene-vinyl acetate copolymer layer is cross-linked and cured to have the adhesion of the ethylene-vinyl acetate copolymer layer to the glass plate of not less than 3N/cm, preferably not less than 5 N/cm, particularly not less than 10N/cm, the adhesion being measured according to JIS K 6854-2.

The heat ray-shielding glass and the heat ray-shielding laminated glass of the present invention are prepared, for example, by superposing the above-mentioned laminate or intermediate film and glass plate(s) and degassing, and then pressing on heating. These steps are carried out by means of, for example, a vacuum bag method and a nip roll method. This can bond and combine each film and glass plate(s).

As for the conditions for the preparation of the heat ray-shielding glass and the heat ray-shielding laminated glass, for example, the laminate of the invention and a glass plate are temporarily bonded at a temperature of 80 to 120° C., and then heated at a temperature of 100 to 150° C., especially about 130° C., for 10 minutes to 1 hour to cross-link the EVA layer. The heat treatment may be carried out under pressure. In this case, the pressure is preferably in the range of 1.0×10³ Pa to 5.0×10⁷ Pa. Cooling after the cross-linking is carried out at room temperature. The cooling is preferably conducted rapidly.

The glass plate in the invention may be any transparent substrates. For example, glass plates such as a green glass plate, a silicate glass plate, an inorganic glass plate and a colorless transparent glass plate, and substrates or plates of plastic films as well can be used. Examples of the plastic films include polyethylene terephthalate (PET), polyethylene naphthalate (PEN), polyethylene butyrate and polymethyl methacrylate (PMMA). A glass plate is preferred in view of weather resistance and impact resistance. The thickness of the glass plate generally is in the range of 1 to 20 mm. As glass plates arranged in both sides of the laminated glass, the same substrates or a combination of different substrates may be used. The combination is determined in view of the strength of substrates and uses of laminated glasses.

### EXAMPLES

### Example 1-7, Comparative Example 1-7

1. Preparation of an EVA Film (EVA Layer) Containing a Silane Coupling Agent.

The materials of the formulation set forth in Tables 1 and 2 were introduced into a roll mill and kneaded at 70° C. to prepare a composition for an EVA film. The composition for an EVA film was subjected to calendaring processing at 70° C. and then cooled to give an EVA film (thickness: 0.4 mm).

2. Preparation of a Fluoro Resin Layer Containing a Tungsten Oxide and/or Composite Tungsten Oxide.

A coating liquid for a fluoro resin layer shown below was applied onto a PET film (200 μm) with a bar coater, and dried at 80° C. for 30 minutes to form a fluoro resin layer having a thickness of 1 μm.

(Formulation)

A fluoro resin having functional groups (solid content: 15% by weight, MIBK: 85% by weight, Optool AR-110 (the above-mentioned polymer A), available from Daiklin Industries, Ltd.)) 100 parts by weight,

Cesium tungsten oxide (Cs_{0.33}WO₃, solid content: 20% by weight, MIBK: 80% by weight) 100 parts by weight.

3. Preparation of a Heat Ray-Shielding Laminate

The obtained EVA film was superposed on the obtained fluoro resin layer formed on the PET film, and they were bonded with each other at 100° C. for 3 minutes by means of a vacuum laminator to obtain a heat ray-shielding laminate.

### Evaluation Methods

(1) Storage Stability Six Months after the Lamination

(i) Initial Adhesion to Glass

A glass plate (thickness: 3 mm) was superposed on the EVA layer of the heat ray-shielding laminate obtained, and then they were temporarily bonded by using a vacuum laminator at 100° C. for 100 minutes, and then heated in an oven at 120° C. for 90 minutes to cross-link the EVA layer and combine them. This gave a sample.

According to a 180° peel test (JIS K 6854-2, 1999), adhesion to glass (N/cm) of the EVA layer of the sample was determined, as shown in FIG. 8, by peeling a part of the EVA layer 12 from the glass plate 16 and folding the EVA layer 12 at an angle of 180°, and then measuring peel strength at a tensile speed of 100 mm/min by means of a tensile testing machine (Autograph, manufactured by Shimadzu Co., LTD). The measured peel strength denotes the adhesion to glass.

(ii) Adhesion after Six-Month Storage.

The heat ray-shielding laminate obtained was left at 30° C. and 80% RH for six months. Then a glass plate was superposed on the EVA layer of the laminate, and then they were temporarily bonded by using a vacuum laminator at 100° C. for 10 minutes, and then heated in an oven at 120° C. for 90 minutes to cross-link the EVA layer and combine them. The adhesion to glass of the EVA layer was measured in the same manner as described above.

The results are shown in Table 1 and Table 2.

TABLE 1

| | | Ex. | Ex. | Ex. | Ex. | Ex. | Ex. | Ex. |
|---|---|---|---|---|---|---|---|---|
| | | 1 | 2 | 3 | 4 | 5 | 6 | 7 |
| Formulation | EVA^{*1} | 100 | 100 | 100 | 100 | 100 | 100 | 100 |
| (parts by weight) | Crosslinker^{*2} | 3.0 | 3.0 | 3.0 | 3.0 | 3.0 | 3.0 | 3.0 |
| | Cross-linking auxiliary^{*3} | 2.0 | 2.0 | 2.0 | 2.0 | 2.0 | 2.0 | 2.0 |
| | Silane coupling agent 1^{*4} | 0.5 | — | — | 0.1 | 2.0 | — | — |
| | Silane coupling agent 2^{*5} | — | 0.5 | — | — | — | — | — |
| | Silane coupling agent 3^{*6} | — | — | 0.5 | — | — | 0.1 | 2.0 |
| | Silane coupling agent 4^{*7} | — | — | — | — | — | — | — |
| | Silane coupling agent 5^{*8} | — | — | — | — | — | — | — |
| | Number of carbon atoms of alkoxy group in | 2 | 2 | 5 | 2 | 2 | 5 | 5 |
| | silane coupling agent | | | | | | | |
| Evaluation | Initial adhesion to glass (N/cm) | 15 | 16 | 12 | 14 | 16 | 11 | 13 |
| | Adhesion to glass after 6-month storage (N/cm) | 14 | 14 | 11 | 12 | 15 | 10 | 12 |
| | Others | — | — | — | — | — | — | — |

NOTE)
^{*1}The content of vinyl acetate in EVA is 26% by weight.
^{*2}Crosslinker: t-butylperoxy-2-ethylhexylcarbonate
^{*3}Cross-linking auxiliary: triallyl isocyanurate
^{*4}Silane coupling agent 1: γ-methacryloxypropyltriethoxysilane
^{*5}Silane coupling agent 2: vinyltriethoxysilane
^{*6}Silane coupling agent 3: γ-methacryloxypropyltripentoxysilane
^{*7}Silane coupling agent 4: γ-methacryloxypropyltrimethoxysilane
^{*8}Silane coupling agent 5: γ-methacryloxypropyltrihexoxysilane

TABLE 2

| | | Co. | Co. | Co. | Co. | Co. | Co. | Co. |
|---|---|---|---|---|---|---|---|---|
| | | Ex. 1 | Ex. 2 | Ex. 3 | Ex. 4 | Ex. 5 | Ex. 6 | Ex.7 |
| Formulation | EVA^{*1} | 100 | 100 | 100 | 100 | 100 | 100 | 100 |
| (parts by weight) | Crosslinker^{*2} | 3.0 | 3.0 | 3.0 | 3.0 | 3.0 | 3.0 | 3.0 |
| | Cross-linking auxiliary^{*3} | 2.0 | 2.0 | 2.0 | 2.0 | 2.0 | 2.0 | 2.0 |
| | Silane coupling agent 1^{*4} | — | — | — | — | 3.0 | — | 0.05 |
| | Silane coupling agent 2^{*5} | — | — | — | — | — | — | — |
| | Silane coupling agent 3^{*6} | — | — | — | — | — | 3.0 | — |
| | Silane coupling agent 4^{*7} | 0.5 | — | 0.1 | — | — | — | — |
| | Silane coupling agent 5^{*8} | — | 1.0 | — | — | — | — | — |
| | Number of carbon atoms of alkoxy group in | 1 | 6 | 1 | — | 2 | 5 | 2 |
| | silane coupling agent | | | | | | | |
| Evaluation | Initial adhesion to glass (N/cm) | 20 | 2 | 18 | 0 | 4 | 4 | 4 |
| | Adhesion to glass after 6-month storage (N/cm) | 0 | 0 | 0 | — | 3 | 3 | 2 |
| | Others | — | — | — | — | Bleed- | Bleed- | — |
| | | | | | | out | out | |

NOTE)
^{*1-8}as described above

### Evaluation Results

The EVA layers of Examples 1-7 comprising silane coupling agents having alkoxy groups having 2 to 5 carbon atoms as hydrolizable groups (i.e., silane coupling agents in which R¹ of the above-mentioned formula (I) is an alkyl group having 2 to 5 carbon atoms) have high initial adhesion and lower reduction in the adhesion after the six-month storage.

On the other hand, the EVA layers of Comparative Examples 1 and 3 comprising the silane coupling agent having alkoxy groups having one carbon atom have large reduction in the adhesion after the six-month storage. The EVA layer of Comparative Example 2 comprising the silane coupling agent having alkoxy groups having six carbon atoms has poor initial adhesion. As shown in Examples 5 to 7, even if the silane coupling agents comprising alkoxy groups having two to five carbon atoms as hydrolysable groups are used, they bleed out when the content is 3.0 parts by weight, and sufficient adhesion cannot be obtained when the content is 0.05 parts by weight.

### INDUSTRIAL APPLICABILITY

The use of the heat ray-shielding laminate of the invention which has excellent storage stability can efficiently produce heat ray-shielding glasses and heat ray-shielding laminated glasses.

### DESCRIPTION OF REFERENCE NUMBER

10, 20 Heat ray-shielding laminate
12, 22, 42 EVA layer
13, 23, 43 Transparent plastic film
14, 24, 44 Fluoro resin layer
45 Adhesive resin layer
16, 26, 46A, 46B Glass plate
40 Heat ray-shielding intermediate film for a laminated glass
50, 60 Heat ray-shielding glass
70 Hear ray-shielding laminated glass

1. A heat ray-shielding laminate which comprises an ethylene-vinyl acetate copolymer layer containing a silane coupling agent and a fluoro resin layer containing a tungsten oxide and/or composite tungsten oxide,
wherein the ethylene-vinyl acetate copolymer layer and the fluoro resin layer are arranged adjacent to each other, or arranged in the form of outermost layers which face each other,
wherein the silane coupling agent is represented by the following formula (I)
R²—Si(OR¹)₃ (I)
in which each R¹ is an alkyl group having 2 to 5 carbon atoms, and R² is an ethylenically unsaturated group or a group having an ethylenically unsaturated group, and
wherein the silane coupling agent is contained in an amount of 0.1 to 2.5 parts by weight based on 100 parts by weight of the ethylene-vinyl acetate copolymer.

2. The heat ray-shielding laminate according to claim 1, wherein each R¹ is an ethyl group.

3. The heat ray-shielding laminate according to claim 1, wherein after the laminate having the ethylene-vinyl acetate copolymer layer and the fluoro resin layer which are adjacent to each other is allowed to stand for six months under conditions of a temperature of 30° C. and a humidity of 80% RH, a glass plate is superposed on the ethylene-vinyl acetate copolymer layer and then the ethylene-vinyl acetate copolymer layer is cross-linked and cured to have the adhesion of the ethylene-vinyl acetate copolymer layer to the glass plate of not less than 3N/cm, the adhesion being measured according to JIS K 6854-2.

4. The heat ray-shielding laminate according to claim 1, which further comprises a transparent plastic film.

5. A heat ray-shielding intermediate film for a laminated glass, which comprises the heat ray-shielding laminate as defined in claim 1.

6. A film roll obtained by winding the heat ray-shielding laminate as defined in claim 1 or the heat ray-shielding intermediate film for a laminated glass as defined in claim 5.

7. A heat ray-shielding glass obtained by using the heat ray-shielding laminate as defined in claim 1.

8. A laminated glass obtained by using the heat ray-shielding intermediate film as defined in claim 5.
